(19) United States
(12) Patent Application Publication
(10) Pub. No.: US 2022/0414531 A1
(43) Pub. Date: Dec. 29, 2022

(54) MITIGATING ADVERSARIAL ATTACKS FOR SIMULTANEOUS PREDICTION AND OPTIMIZATION OF MODELS

(71) Applicant: International Business Machines Corporation, Armonk, NY (US)

(72) Inventors: YUYA JEREMY ONG, San Jose, CA (US); NATHALIE BARACALDO ANGEL, San Jose, CA (US); ALY MEGAHED, San Jose, CA (US); Ebube Chuba, San Jose, CA (US); Yi Zhou, San Jose, CA (US)

(21) Appl. No.: 17/358,804

(22) Filed: Jun. 25, 2021

(51) Int. Cl. G06N 20/00; G06N 5/02

(52) U.S. Cl. CPC G06N 20/00; G06N 5/02

(57) ABSTRACT

An approach for providing prediction and optimization of an adversarial machine-learning model is disclosed. The approach can comprise of a training method for a defender that determines the optimal amount of adversarial training that would prevent the task optimization model from taking wrong decisions caused by an adversarial attack from the input into the model within the simultaneous predict and optimization framework. Essentially, the approach would train a robust model via adversarial training. Based on the robust training model, the user can mitigate against potential threats by (adversarial noise in the task-based optimization model) based on the given inputs from the machine learning prediction that was produced by an input.

### BACKGROUND

The present invention relates generally machine learning, and more particularly to leverage adversarial training for task optimization.

Many machine learning models today are integrated within the context of a larger system as part of a key component for decision making. In many applications, there are some uncertain parameters that need to be predicted via some machine learning (ML) model. Those predictions are subsequently fed into some task optimization model that recommends the optimal actions that need to be taken in order to maximize some utility/minimize some cost. Concretely, the result of a model is used as inputs towards an optimization process to either minimize some defined cost function.

Recently, there has been an increase in cyber attacks, where one kind of such attacks is that an adversary evades a ML model by modifying the sample that the ML is meant to be applied to. For example, an image classifier can misclassify an image, when they are subject to some perturbation due to some adversarial attacks on the input data or model.

### SUMMARY

Aspects of the present invention disclose a computer-implemented method, a computer system and computer program product for providing prediction and optimization of an adversarial machine-learning model. The computer implemented method may be implemented by one or more computer processors and may include receiving a set of input data associated with a training model, wherein the input data comprises of a training dataset, a testing dataset, task-defined cost function, possible action ranges, historical dataset and pre-train model weights; determining a test optimal action value from the testing dataset based on threat assumption and the possible action ranges; determining a training optimal action value from the training dataset based on output features of the training dataset and the possible action ranges; computing a first distance between the test optimal action value and the training optimal action value; computing a prediction loss function based the historical dataset; computing a second distance between the possible action ranges and the training optimal action value; computing the task-defined cost function based on the possible action ranges and the output prediction from the testing dataset; calculating a total loss based on the first distance, the prediction loss function, the second distance and the task-defined cost function; calculating a gradient of the total loss function; performing a backpropagation on one or more parameters associated with the training model; determining if convergence has occurred; and responsive to the convergence has occurred, outputting the optimal actions, optimal learned model parameter and optimal task-defined objective function.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

### BRIEF DESCRIPTION OF THE DRAWINGS

Preferred embodiments of the present invention will now be described, by way of example only, with reference to the following drawings, in which:

FIG. 1 is a functional block diagram illustrating an adversarial training environment, designated as 100, in accordance with an embodiment of the present invention;

FIG. 2A, FIG. 2B, FIG. 2C, and FIG. 2D comprise a flowchart diagram, designated as 200, illustrating additional components to existing current technology in machine learning, specifically optimizing and prediction models associated with mitigating adversarial attacks, in accordance with an embodiment of the present invention;

FIG. 3 is a high-level flowchart illustrating the operation of adversarial component 111, designated as 300, in accordance with an embodiment of the present invention; and

FIG. 4 depicts a block diagram, designated as 400, of components of a server computer capable of executing the adversarial component 111 within the adversarial training environment, of FIG. 1, in accordance with an embodiment of the present invention.

### DETAILED DESCRIPTION

Adversarial machine learning is a machine learning technique that attempts to deceive learning models by supplying it with “deceptive” (e.g., disguised, etc.) input. The most common reason is to cause a malfunction in a ML (machine learning) model. One example illustrating a cyber-attack (leveraging adversarial machine learning) comprises of an airport security application, where the system predicts which luggage are more likely to need to go through further inspection through a ML model, and then allocates the constrained inspection resources depending on that prediction, via some optimization model. An adversary could print an adversarial patch to some of the luggage to cause the ML model to misclassify these luggage, and then lead the optimization model to take wrong decisions on which luggage to inspect more thoroughly (e.g., inspect or not inspect at all, inspect some, etc.) and how much resources to allocate for the inspection (e.g. how many employees or police dogs to send, etc.).

Embodiments of the present invention recognizes the deficiencies in the current state of art and provides an approach for addressing those deficiencies. One approach can comprise of a training method for a defender that determines the optimal amount of adversarial training that would prevent the task optimization model from taking wrong decisions caused by an adversarial attack from the input into the model within the simultaneous predict and optimization framework. Essentially, the approach would train a robust model via adversarial training. Based on the robust training model, the user can mitigate against potential threats by (adversarial noise in the task-based optimization model) based on the given inputs from the machine learning prediction that was produced by an input.

The approach can be summarized by the following general steps: (i) pre-training by the computing device a machine learning model using a training dataset; (ii) discovering by the computing device one or more adversarial training examples for adversarial training of the machine learning model which may be poisoned; (iii) discovering by the computing device one or more non-poisoned training examples for the machine learning model; (iv) calculating by the computing device a difference vector between the discovered one or more adversarial training examples and the discovered one or more non-poisoned training examples; and (v) providing by the computing device further training data within the difference vector for further training of the machine learning model.

Many machine learning models are integrated within the context of a larger system as part of a key component for decision making. Thus, the result of a model is used as inputs towards an optimization process to either minimize some defined cost function. Traditionally, such tasks are done independently where users first build prediction models, then use the output of the models to generate decision values based on the prediction separately. Embodiment considers the joint optimization of the prediction model and the optimization function in an end-to-end process, as opposed to two independent components.

A problem statement will be described as it pertains to the current state of the art. Problem Statement: Consider a machine learning model, with the following notation: F(X)=Pr(Y|X; θ)=Y. This machine learning model is used in a larger task optimization process for some defined action. This process makes decisions Z, the action taken, based on the machine learning model's prediction, Ŷ, and further incurs some cost as defined by, G(Y,Z).

The question is, “how does one learn the appropriate model (i.e. prediction) such that the process can make a decision that incurs the smallest cost (i.e., optimization)?” Formally, this can define this as:

$${Z}^{*} ( X ; θ ) = {arg min}_{z} {𝔼}_{y \sim Pr ( Y \vert X )} [ G ( Y , Z ) ] .$$

Traditionally, the main focus is on the predictions alone, and hope the predictions are good enough, such that the optimization can identify the optimal task action (i.e., this would assume that accurate predictions would lead to the optimal task optimization actions). In other words, a user solves the two problems, prediction and optimization, separately and sequentially. However, in the simultaneous predict and optimize framework, embodiment of the present invention can perform these two optimizations jointly.

Another example, illustrating adversarial attack relates to optimization of image recognition by satellites. Consider a scenario where a satellite is deployed to perform surveillance and act on potential threats. Due to the large scale of the task at hand machine learning models that classify what it has seen on the ground are often used. On top of this classifier, an optimization to deploy forces and act on potential threats is performed. An adversary may add an adversarial patch to the roof of a facility, vehicle or object to avoid detection from the satellite images leading to undesirable consequences for the defender who would be unaware of the threat.

In yet another example, illustrating adversarial attack relates to forecasting demands and optimization in the supply chain logistic field. In supply chain optimization for inventory transportation and stocking of critical products (i.e. weapons, aircraft parts, medical equipment), user builds forecast models for predicting the demand of a given critical product and the task optimization optimizes the various logistical optimization decisions such as what parts to transport, optimal quantities of each product to transport, and what price to purchase some of these products. Here, an adversary may want to disrupt the logistical operation of the supply chain operation by having the model incorrectly forecast the product demand such that the least optimal decisions would be made. An adversary can intercept and inject erroneous noise into the data streams the predictive model may use to generate forecasts, which leads to incorrect forecasts and hence sub-optimal decisions. The consequence of such sub-optimal or incorrect decisions can lead to billions of dollars of losses to businesses and affect other major industries which rely on that critical product.

Other embodiments of the present invention may recognize one or more of the following facts, potential problems, potential scenarios, and/or potential areas for improvement with respect to the current state of the art: i) introducing a method to jointly train a robust model via adversarial training for simultaneous predict and optimization models, and (ii) providing a plan on how to mitigate against potential threats posed by adversarial noise in a task-based optimization model, given inputs from a machine learning prediction that was produced by an input which was potentially perturbed by an adversary.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

It should be understood that the Figures are merely schematic and are not drawn to scale. It should also be understood that the same reference numerals are used throughout the Figures to indicate the same or similar parts.

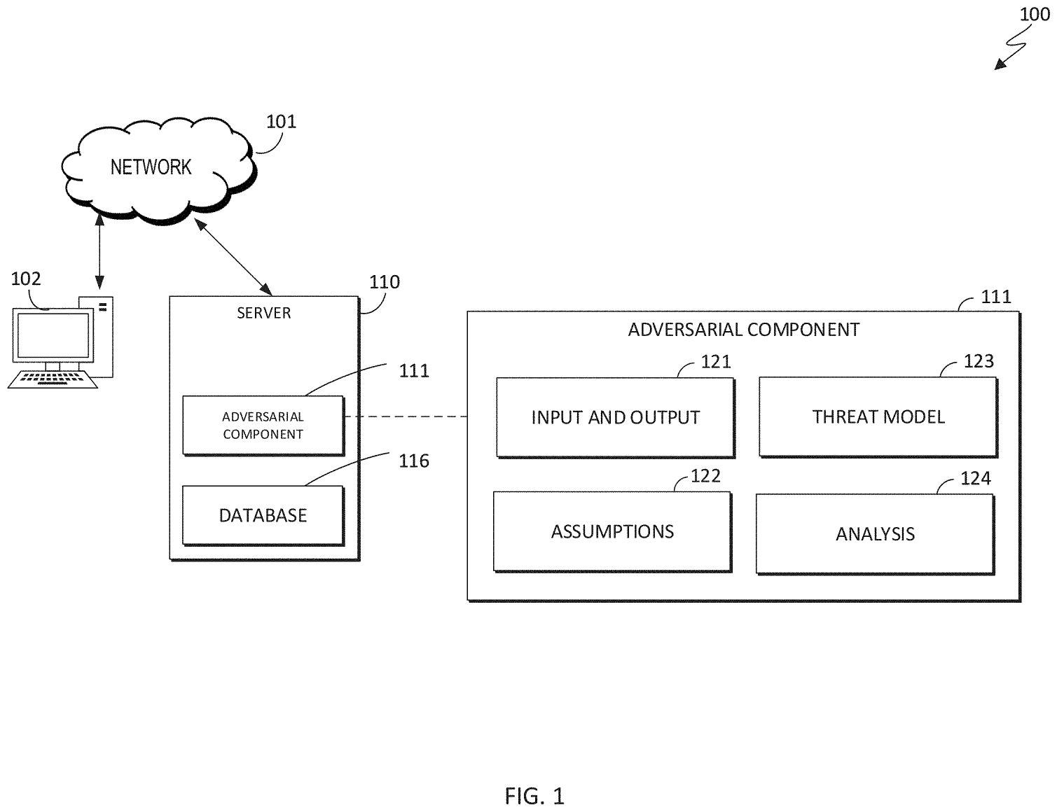

FIG. 1 is a functional block diagram illustrating an adversarial training environment, designated as 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Adversarial training environment 100 includes product network 101, client computing device 102, target object 104 and server 110.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between server 110 and other computing devices (not shown) within Adversarial training environment 100. It is noted that other computing devices can include, but is not limited to, any electromechanical devices capable of carrying out a series of computing instructions.

Client computing devices 102 are computing devices that can be a machine learning server or provides a GUI (graphical user interface) to a machine learning server (i.e., accepting commands/instructions from users).

Server 110 and client computing devices 102 can be a standalone computing device, a management server, a web server, a mobile computing device, or any other electronic device or computing system capable of receiving, sending, and processing data. In other embodiments, server 110 and client computing devices 102 can represent a server computing system utilizing multiple computers as a server system, such as in a cloud computing environment. In another embodiment, server 110 and client computing devices 102 can be a laptop computer, a tablet computer, a netbook computer, a personal computer (PC), a desktop computer, a personal digital assistant (PDA), a smart phone, or any other programmable electronic device capable of communicating other computing devices (not shown) within adversarial training environment 100 via network 101. In another embodiment, server 110 and client computing devices 102 represents a computing system utilizing clustered computers and components (e.g., database server computers, application server computers, etc.) that act as a single pool of seamless resources when accessed within adversarial training environment 100.

Embodiment of the present invention can reside on server 110 or on client computing devices 102. Server 110 includes adversarial component 111 and database 116.

Adversarial component 111 provides the capability of providing a training method for a defender that determines the optimal amount of adversarial training that would prevent the task optimization model from making wrong decisions (i.e., caused by an adversarial attack from the input into the model within the simultaneous predict and optimization framework). Adversarial component 111 contains subcomponents: input and output component 121, assumption component 122, threat model component 123 and analysis component 124.

Database 116 is a repository for data used by adversarial component 111. Database 116 can be implemented with any type of storage device capable of storing data and configuration files that can be accessed and utilized by server 110, such as a database server, a hard disk drive, or a flash memory. Database 116 uses one or more of a plurality of techniques known in the art to store a plurality of information. In the depicted embodiment, database 116 resides on server 110. In another embodiment, database 116 may reside elsewhere within adversarial training environment 100, provided that adversarial component 111 has access to database 116. Database 116 may store information associated with, but is not limited to, convergence/termination criteria, threat model assumptions (for a defender and/or an adversary), training dataset, testing dataset, task-defined cost function, action ranges, optimal action, optimal task-defined objective function, optimal learned model parameter, variables associated with the machine learning models, pre-trained models and model predictions.

As is further described herein below, input and output component 121 of the present invention provides the capability of managing inputs (data) and outputs (data) associated with training a model as it relates to prediction and task optimization.

Inputs can be related to incoming data. Data related inputs (from a training set) can be designated as a Training Dataset. The training dataset has the following formula, [symbol] ₜᵣₐᵢₙ={(x₁, y₁, z₁), (xₙ, yₙ, zₙ)}, wherein X=Input Features, Y=Output Features, Z=Action Values, and n=Total Number of Samples in the training dataset. Other nomenclature related to mathematical functions and/or dataset are listed as follows: Testing Dataset: [symbol] ₜₑₛₜ={x₁, . . . , xₘ}; Task-Defined Cost Function=g(z,y); and

Possible Action Ranges=\tilde{Z}. It is noted that task-defined cost function are not set permanent and is dependent on the goal of the user.

Data related to outputs are listed as follow: Optimal Action=Z*; Optimal Task-Defined Objective Function=g*(Z*, Y); and Optimal Learned Model Parameter=θ.

As is further described herein below, assumption component 122 of the present invention provides the capability of managing objective assumption(s) and objective function(s). Objective assumptions can be defined as assumptions made to optimize objective function. As it relates to machine learning model, the following assumptions are made: (i) the machine learning model, y˜Pr(y|x, z; θ), is differentiable, (ii) the joint weighted cost function is differentiable with respect to the inputs, (iii) assume that the task-optimization function is a linear function with respect to the input x and action value z. As long as x and z are continuous, the function is differentiable and (iv) the task optimization constraints are also linear with respect to x and z as well. Given the assumptions above, a user can use stochastic gradient descent or any other mathematical operation to optimize an objective function.

An objective function is the function the user wishes to minimize or maximize as it relates to optimizing task and predicting loss. For example, given an input, Xₜₑₛₜ, which may or may not be perturbed by an adversary using some noise, δ_{A}, the user can generate a prediction from the machine learning model to produce ŷₜₑₛₜ which is used to find the optimal action, z*, that will minimize the task-constrained objective cost function, g(z,y). Minimizing or maximizing a function, a user can leverage any existing mathematical operation. For this example, “argmin” is used to minimizing the above objective function with respect to a specific action z:

$${arg min}_{z} {𝔼}_{y \sim Pr ( y \vert x + {δ}_{A} , z ; θ )} [ ℊ ( z , y ) ] .$$

To train a model which jointly considers both the machine learning predictive loss function and the task-constrained optimization function, the user can define the following joint weighted cost function, as such:

F(yₜᵣₐᵢₙ,ŷₜᵣₐᵢₙ,yₜₑₛₜ,\tilde{z},z*ₜᵣₐᵢₙ,z*ₜₑₛₜ)=l(yₜᵣₐᵢₙ,ŷₜᵣₐᵢₙ)·ω(\tilde{z},z*ₜᵣₐᵢₙ,α)+g(\tilde{z}ₖ,yⱼ_{ₜₑₛₜ})·γ(z*ₜₑₛₜ,z*ₜᵣₐᵢₙ,β)

where l(yⱼ_{ₜᵣₐᵢₙ}, ŷⱼ_{ₜᵣₐᵢₙ}) is the predictive loss function, ω(\tilde{z}, z*ₜᵣₐᵢₙ, α) is the weight for the predictive loss function, and γ(z*ₜₑₛₜ, z*ₜᵣₐᵢₙ, β) weight function defined for the task-defined cost function, ω(\tilde{z}, z*ₜᵣₐᵢₙ, α) is an increasing function with respect to the distance between \tilde{z} and z*ₜᵣₐᵢₙ and γ(z*ₜₑₛₜ, z*ₜᵣₐᵢₙ, β) is a decreasing function with respect to the distance between zₜₑₛₜ and z*ₜᵣₐᵢₙ. The user can then use the above cost function as an objective to optimize over both the predictive loss and the task-constrained loss function (i.e., mitigate threats posed by adversarial noise in a task-based optimization model).

As is further described herein below, threat model component 123 of the present invention provides the capability of managing threat model assumptions and objectives. Threat model assumptions and objectives can be related to (i) an adversary and (ii) a defender.

In an adversary situation, the user can consider a targeted attack scenario, where the adversary wants to trigger a certain action given a specific input. The adversary's objective is defined as:

$${min}_{{δ}_{A}} {max}_{{z}_{A}} {𝔼}_{x , y \sim 𝒟} [ F ( x + {δ}_{A} , y , {z}_{A} ) - F ( x , y , {z}^{*} ) ] ,$$

where z_{A} is the targeted action and z_{A}≠z*.

The goal of the adversary is to maximize the difference of the weighted cost function computed based on the targeted adversarial input and the true values, while using the minimal amount of perturbation noise as possible. The training data set is clean and will not be changed at any point. The adversary has White Box Access (i.e., full knowledge) of the following: (i) model parameters (θ), (ii) task optimization function [g(z,y)], (iii) joint weighted cost function and (iv) training dataset. However, the adversary can only change Xₜₑₛₜ by means of perturbing the input by some δ_{A} (i.e., adversarial noise).

In a defender situation, the user can consider a targeted defense scenario, where the defender filters for a specific adversarial input. For example, the defender's objective is defined as:

$${z}^{*} ( x , z ; θ ) = {arg min}_{z} {𝔼}_{y \sim Pr ( y \vert x + {δ}_{D} , z ; θ )} [ F ( x , y , z ) ]$$

The goal of the defender is to train a robust model such that the weighted cost function with respect to finding the best action value, while mitigating against potential adversarial attacks from the perturbation noise injected during inference time. The user can assume here that y is not dependent on z and, also knowing y will provide the user with a mapping to the optimal action, z*. In other words, knowing the result of the prediction model, will provide the user with the optimal action.

When the defender samples from the true distribution of the data, the user will know the true label of the prediction y, which the user can use to find the optimal action for that input into the task-constrained cost function.

The user can look at all possible label values that would not lead to z*. The user will maximize the possible loss based on the labels. Given the z*, the user can find the (δ_{D} and retrain the model to find the new theta (θ), and repeat process with new incoming input.

As is further described herein below, analysis component 124 of the present invention provides the capability of determining/analyzing/calculating the following, but it is not limited to, (a) loss functions, (b) distances between datasets, (c) task-defined cost functions, (d) total loss, (e) gradient, (f) backpropagation and (g) repeating until convergence.

Other functionality of analysis component 124 can include, but is not limited to, (i) determining the optimal z*ₜₑₛₜ, (ii) determining the optimal z*ₜᵣₐᵢₙ using yₜᵣₐᵢₙ, (iii) computing the distance between outputs from step (i) and step (ii), (iv) determining the possible action ranges, (v) computing prediction loss with respect to historical data, (vi) compute distance between \tilde{z} and Z*ₜᵣₐᵢₙ, (vii) computing task-defined cost function g(\tilde{z}ₖ, yₜₑₛₜ), (viii) performing feedforward inference for each different action ranges, (ix) solving for optimal set of actions z*ₜₑₛₜ, (x) computing difference between output for scalar values for |z*ₜₑₛₜ−z*ₜᵣₐᵢₙ| and/or |\tilde{z}−z*ₜᵣₐᵢₙ|, (xi) computing Wasserstein distance between z*ₜₑₛₜ and z*ₜᵣₐᵢₙ and/or \tilde{z} and Z*ₜᵣₐᵢₙ (for distributions-based values), (xii) utilizing weights corresponding to the prediction loss and (xiii) utilizing weights corresponding to the task-optimization cost.

Regards to (referring to the previous list of other functionality for analysis component 124), items (i) and (ii), “determining the best . . . ”, can be further defined as minimizing or maximizing a function. For example, an “argmin” or “argmax” can be utilized. The optimal action (indicated by z*) is defined by finding the z value that minimizes the task cost function g(z,y) with respect to y, which is defined by Pr(y|x+δ_A) (i.e., user's machine learning model taking the input from the adversarial model), and a select action value z (based on some range of actions that users try in the model).

Regards to (referring to the previous list of other functionality for analysis component 124), items (iii), (x) and (xi), “computing the distance . . . ”, can be further defined as leveraging any known distance calculation, such as using, a simple difference, Wasserstein metric, Euclidean distance and cosine similarity. Another calculation method if used for scalar-based values then is to compute the difference between the output defined as: |z*ₜₑₛₜ−z*ₜᵣₐᵢₙ|. Otherwise, if computing for distributions-based values then use the Wasserstein Distance to compute between zₜₑₛₜ and zₜᵣₐᵢₙ.

Regards to (referring to the previous list of other functionality for analysis component 124), item (v), “computing prediction loss . . . ”, can be further defined as using any known method to compute a simple difference between mathematical elements, such as, using mean squared error and root mean squared error. It is important to note that the loss can vary depending on the machine learning task being performed. For example related classification, this can be cross entropy loss, or for regression, this can be the loss functions that has been previously defined (i.e., l(yⱼ_{ₜᵣₐᵢₙ}, ŷⱼ_{ₜᵣₐᵢₙ})).

Another calculation method if used for scalar-based values then is to compute the difference between the output defined as: |z*ₜₑₛₜ−z*ₜᵣₐᵢₙ|. Otherwise, if computing for distributions-based values then use the Wasserstein Distance to compute between z*ₜₑₛₜ and z*ₜᵣₐᵢₙ.

Regards to (referring to the previous list of other functionality for analysis component 124), item (vii), “computing task define cost function . . . ”, can be further defined as computing a given task function (i.e., g(z,y)) with known computational methodology. The task function, g(z,y), is a user-defined function that is actually part of the input that the user needs to provide for this algorithm. The task function measures what the user wants to optimize based on the inputs of the provided action z and the input observation y, which comes from the machine learning model output.

Regards to (referring to the previous list of functionality for analysis component 124), “calculating total loss..”, can be further defined as using any known method to derive any loss function in machine learning model. For example, the loss function is the weighted joint function, F(yₜᵣₐᵢₙ, ŷₜᵣₐᵢₙ, yₜₑₛₜ, \tilde{z}, z*ₜᵣₐᵢₙ, z*ₜₑₛₜ)=l(yⱼ_{ₜᵣₐᵢₙ}, ŷⱼ_{ₜᵣₐᵢₙ})·ω(\tilde{z}, z*ₜᵣₐᵢₙ, α)+g (\tilde{z}ₖ, yⱼ_{ₜₑₛₜ})·γ(z*ₜₑₛₜ, z*ₜᵣₐᵢₙ, β) This is what the model uses to optimize the above model to find the best theta, θ, (i.e., parameter of the model).

Regards to (referring to the previous list of functionality for analysis component 124), “computing gradient . . . ” can be further defined as performing a differential mathematical operation, which can be a part of gradient descent optimization algorithms. The procedure leverages the use of an auto differentiation function, which essentially allows user to approximate the gradient of some arbitrary function without having a closed-form function. Another method for computing gradient, can leverage a stochastic optimization methodology, first-order iterative optimization algorithm (gradient descent) or gradient ascent.

Regards to (referring to the previous list of functionality for analysis component 124), “repeat until convergence . . . ”, can be further defined as repeating (i.e., a loop) all the steps until a termination criteria has been met, which allows the process to terminate. The convergence/termination criteria can include, but it is not limited to, (i) a process where the difference between the previous metric of interest and the same metric of interest in the current iteration has not changed by some threshold value defined by the user (or can evaluate this over a window of values in other instances), (ii) the number of epochs (iterations) has been reached (i.e., the epoch threshold can be defined and adjusted by the user) and (iii) the convergence score reaches some user-defined value.

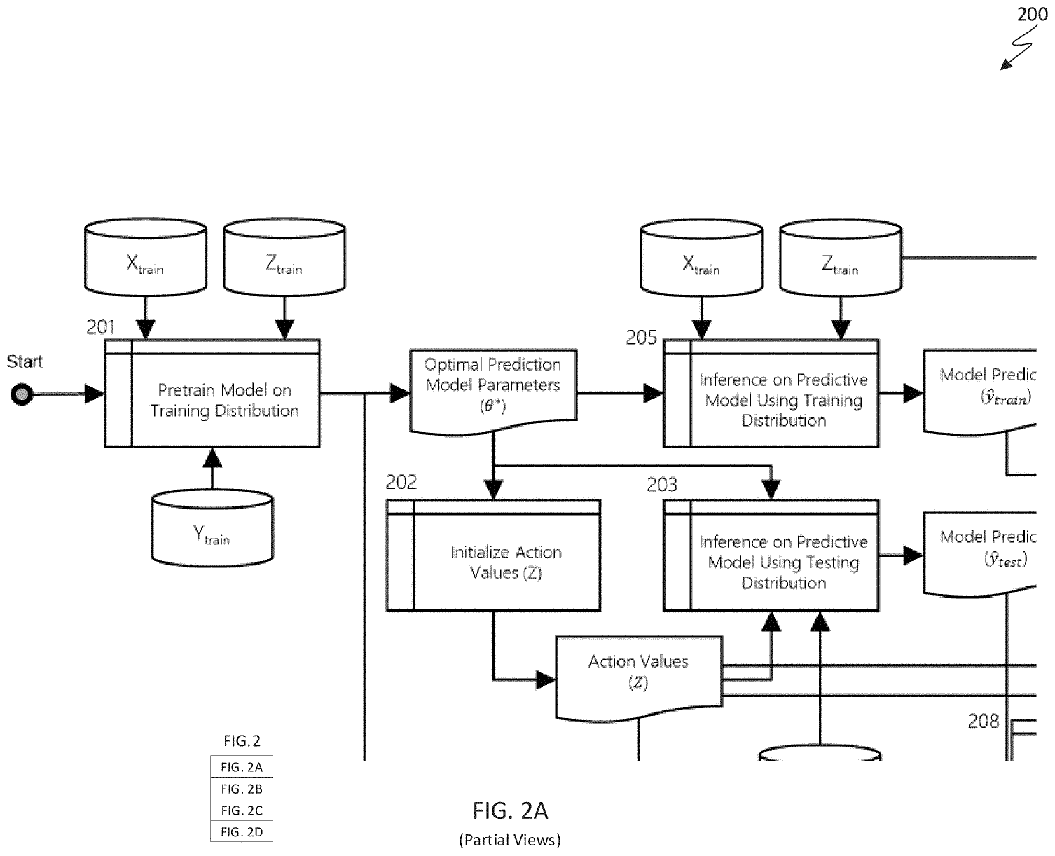

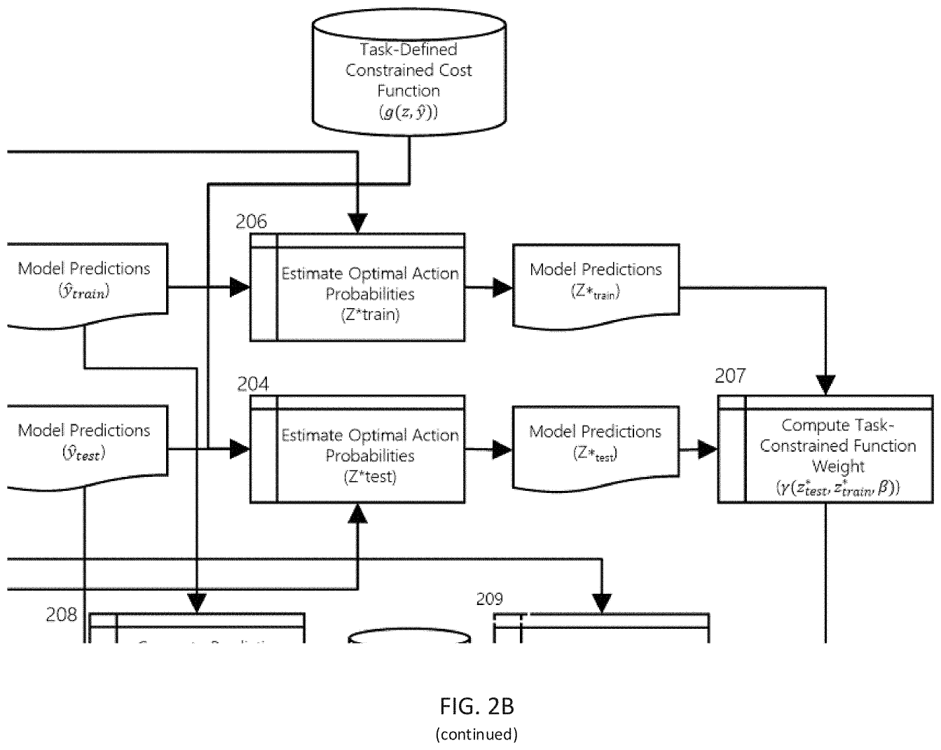

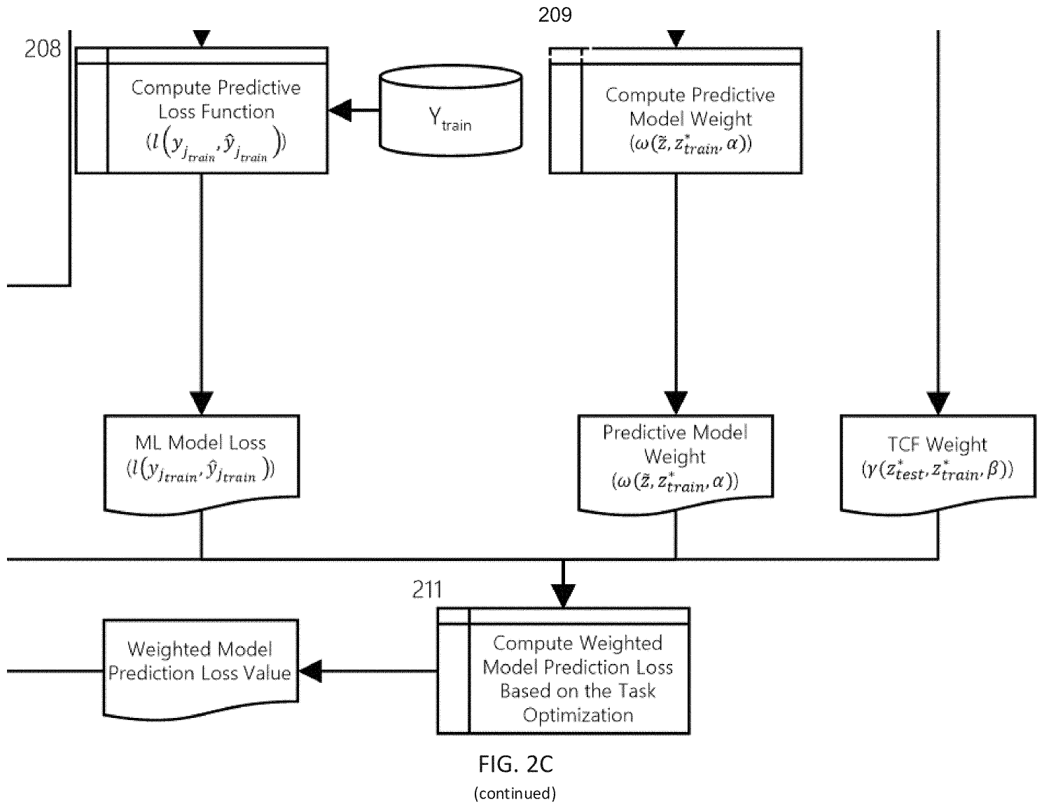

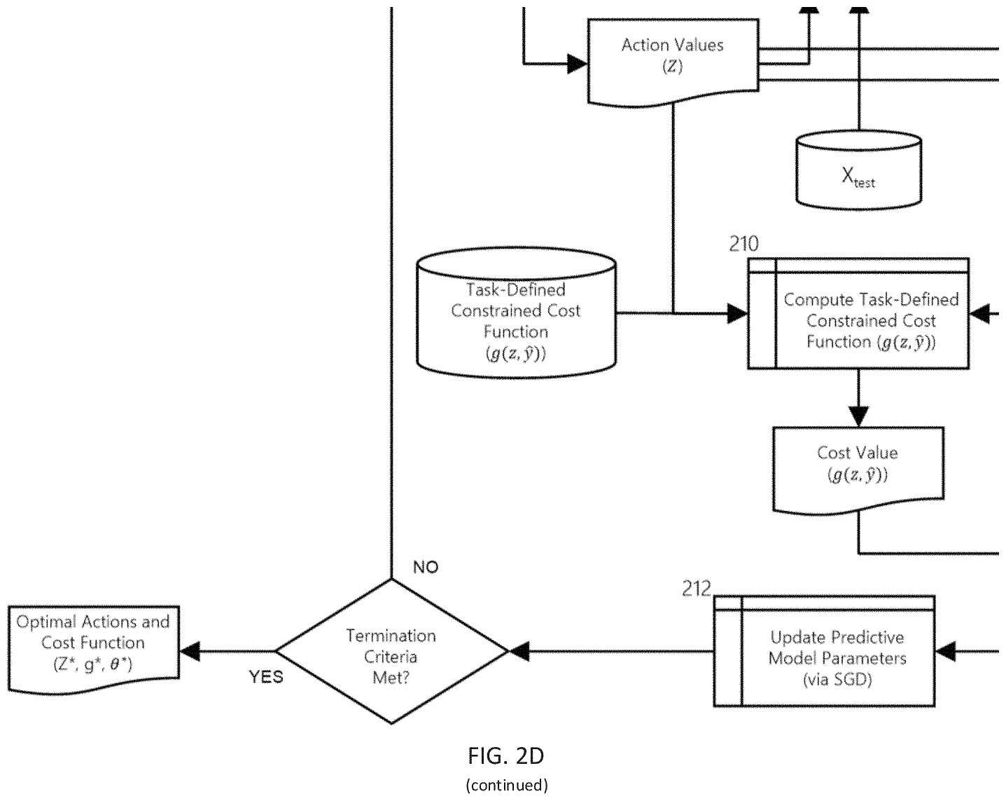

FIG. 2A, FIG. 2B, FIG. 2C, and FIG. 2D comprise a flowchart diagram illustrating additional components to existing current technology in machine learning, specifically optimizing and prediction models associated with mitigating adversarial attacks, in accordance with an embodiment of the present invention.

In the depicted embodiment, there are additional processes/blocks that are included: 201, 202, 203, 204, 205, 206, 207, 208, 209, 210, 211 and 212.

Block 201 is the process to retrieve datasets related to pre-training models for optimal action probabilities (Zₜᵣₐᵢₙ), feature inputs (Xₜᵣₐᵢₙ) and feature outputs(Yₜᵣₐᵢₙ).

Block 202 is the process to initialize action value (z). Block 203 is the process associated with an inference on predictive model using testing distribution. Block 204 is the process associated with estimating optimal action probabilities (Z*test). Block 205 is the process associated with an inference on predictive model using training distribution. Block 206 is the process associated with estimating optimal action probabilities (Z*train). Block 207 is the process associated with computing task-constrained function weights (γ(z*ₜₑₛₜ, z*ₜᵣₐᵢₙ, β)) Block 208 is the process associated with, computing the predictive loss function (l(y_{J train}, ŷⱼ_{ₜᵣₐᵢₙ})).

Block 209 is the process associated with, computing the predictive model weights (ω(\tilde{z}, z*ₜᵣₐᵢₙ, α)). Block 210 is the process associated with, computing task-defined constrained cost function (g (z, ŷ)). Block 211 is the process associated with computing weighted model prediction loss based on the task optimization. Block 212 is the process associated with updating predictive model parameters (via SGD).

A high-level steps/process of one embodiment of the present invention (system for mitigating adversarial attacks for simultaneous optimize and predict models) includes the following steps: (i) pre-train the model on the training dataset, (ii) determines the best z*test with respect to the testing set (x+δ_{A}), with the assumption that the input may be potentially be poisoned, and the possible action ranges, (iii) determines the best z*train using yₜᵣₐᵢₙ and the possible action ranges, (iv) compute the distance between the outputs of step (ii) and step (iii)—a distance measuring the comparison between clean and adversarial actions, (v) compute prediction loss with respect to the historical data comparing the loss between yₜᵣₐᵢₙ and ŷₜᵣₐᵢₙ=Pr(y|x+δ_{D}, z; θ)— prediction loss function that is trained to ensure model robustness via noise added by δ_{D}, (vi) compute distance between \tilde{z} and z*ₜᵣₐᵢₙ—distance to consider the relevant historical training samples with respect to the task optimization cost, (vii) compute task-defined cost function g(\tilde{z}ₖ, yₜₑₛₜ)− used to minimize the task-defined cost function, (viii) derive total loss from values computed by steps (iv)-(vii), (ix) compute gradient and perform backpropagation to update model parameters and (x) repeat steps (ii) to (ix) until convergence of model or some termination criteria.

Termination/Convergence criteria was previously defined and will be repeated as follows. Convergence can be defined as a process where the difference between the previous metric of interest and the same metric of interest in the current iteration has not changed by some threshold value defined by the user (or can evaluate this over a window of values in other instances). The convergence criteria can include, but it is not limited to, (i) the number of epochs (i.e., iterations) has been reached (i.e., epoch threshold value can be defined by the user), (iii) the convergence score reaches some user-defined threshold value.

Regarding step (ii), the following can be used as an additional and/or alternative steps: (a) perform a feedforward inference for each of the different action ranges, given the input testing set to derive a collection of predictions, ŷₜᵣₐᵢₙ and/or (b) solve for the optimal set of actions, z*ₜₑₛₜ, once given the task-defined optimization function g(z,y), the possible action ranges, and the output predictions derived from (a).

Regarding step (iii), the following can be used as an additional step: (a) given the task-defined optimization function g(z,y), the various historical actions, zₜᵣₐᵢₙ, and the historical input values, yₜᵣₐᵢₙ, one can solve for the optimal actions, z*ₜᵣₐᵢₙ.

Regarding step (iv), the distance users want to measure comparing between clean and adversarial actions, the following can be used as an additional step: (a) an embodiment of this is computing the difference between the output defined as: |z*ₜₑₛₜ−zₜᵣₐᵢₙ| (i.e., for scalar-based values) and (b) Another embodiment of this is computing the Wasserstein Distance between z*ₜₑₛₜ and z*ₜᵣₐᵢₙ (i.e., for distributions-based values).

Regarding step (vi), distance to consider the relevant historical training samples with respect to the task optimization cost, the following can be used as an additional and/or alternative step: (a) an embodiment of this is to leverage computing the difference between the output defined as: |\tilde{z}−z*ₜᵣₐᵢₙ|(i.e., for scalar-based values) and/or (b) another embodiment of this is to leverage computing the Wasserstein Distance between \tilde{z} and z*ₜᵣₐᵢₙ (i.e., for distribution-based values).

Regarding step (viii), the following details can be used as an alternative step(s): (a) deriving the total loss can be defined as a weighted sum of step(v) and step (vii) whose weights are dependent on step (iv) and step (vi), (b) an embodiment of this is utilizing weights corresponding to the prediction loss, defined by 1/|\hat{z}−z*ₜᵣₐᵢₙ|^{α} or any function that increases in distance of the \tilde{z} and z*ₜᵣₐᵢₙ or (c) another embodiment of this is utilizing weights corresponding to the task-optimization cost, defined by 1/|z*ₜₑₛₜ−z*ₜᵣₐᵢₙ|^{β} or any function that decreases in distance of the z*ₜₑₛₜ and z*ₜᵣₐᵢₙ.

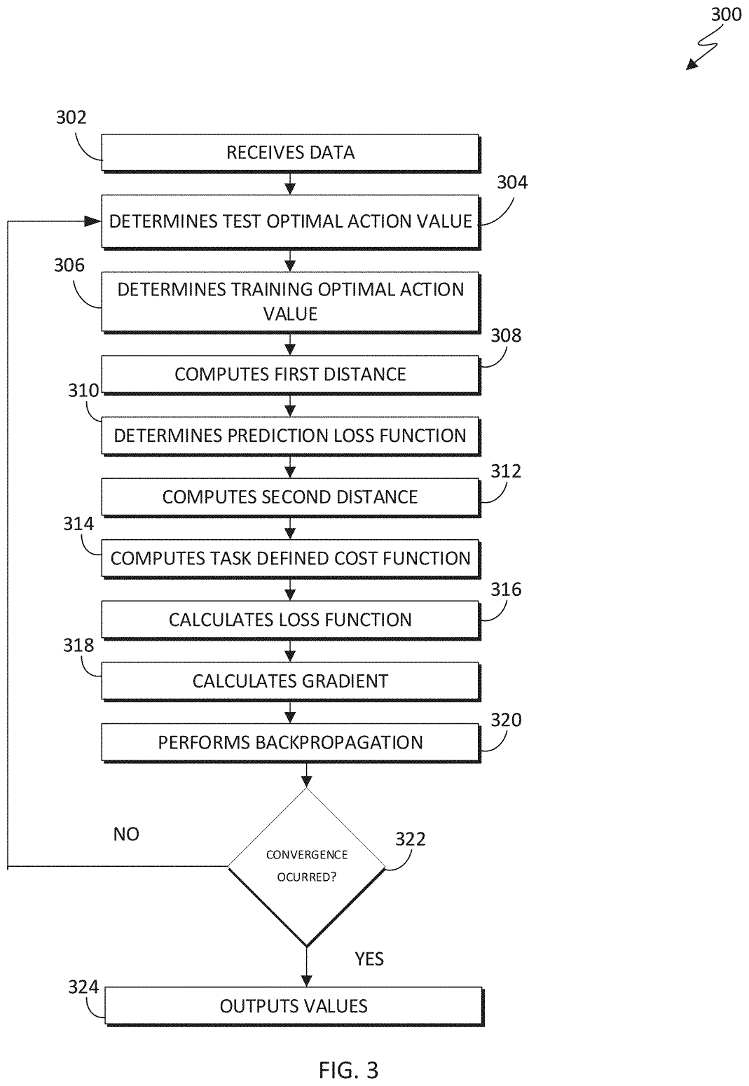

FIG. 3 is a high-level flowchart illustrating the operation of adversarial component 111, designated as 300, in accordance with another embodiment of the present invention.

Adversarial component 111 receives a subsample (step 302). In an embodiment, adversarial component 111, through input and output component 121, receives a subsample dataset from the training set and/or the testing dataset. An adversarial component 111 begins to pre-train model weights. It is noted that assumption component 122 and threat model component 123 are utilized in order to retrieve data related to input and output assumptions and threat model assumptions (e.g., adversary and defender, etc.) along with receiving the testing and training dataset.

Adversarial component 111 determines test optimal action value (step 304). In an embodiment, adversarial component 111, through analysis component 124, determines the best (i.e., optimal) z*ₜₑₛₜ with respect to the testing set (x+δ_{A}), with the assumption (i.e., threat model assumptions) from that the input may be potentially be poisoned, and the possible action ranges (i.e., Z). Recall that the training dataset is defined as, [symbol] ₜᵣₐᵢₙ={(x₁, y₁, z₁), . . . , (xₙ, yₙ, zₙ)}, where x is the input features, y is the output features and z is the action values. It is noted that “best” and “optimal” are user defined and can vary from user and/or objective of the learning model.

In an alternative embodiment, “determines the best z*ₜₑₛₜ” can comprise of the following steps: (a) perform a feedforward inference for each of the different action ranges, given the input testing set to derive a collection of predictions, ŷₜᵣₐᵢₙ and/or (b) given the task-defined optimization function g (z,y), the possible action ranges, and the output predictions derived from (a), users can solve for the optimal set of actions, z*ₜₑₛₜ.

Adversarial component 111 determines the training optimal action value (step 306). In an embodiment, adversarial component 111, through analysis component 124, determines the best z*ₜᵣₐᵢₙ using the historical yₜᵣₐᵢₙ and the possible action ranges.

In an alternative embodiment, “determines the best z*train” can comprise of, solving for the optimal actions, z*ₜᵣₐᵢₙ if given the task-defined optimization function g(z,y), the various historical actions, zₜᵣₐᵢₙ, and the historical input values, yₜᵣₐᵢₙ.

Adversarial component 111 computes a first distance (step 308). In an embodiment, adversarial component 111, through analysis component 124, computes the distance (i.e., first distance) between z*test and z*train (i.e., the distance the user wants to measure comparing between clean and adversarial actions).

In an alternative embodiment, “computes a first distance” (i.e., the distance the user wants to measure comparing between clean and adversarial actions), the following can be used as an additional step, computing the difference between the output defined as: |z*ₜₑₛₜ−zₜᵣₐᵢₙ| (i.e., for scalar-based values). In another embodiment, is to leverage using the computation of a Wasserstein distance between zₜₑₛₜ and z*ₜᵣₐᵢₙ (i.e., for distributions-based values).

Adversarial component 111 determines prediction loss function (step 310). In an embodiment, adversarial component 111, through analysis component 124, computes prediction loss with respect to the historical data comparing the loss between yₜᵣₐᵢₙ and ŷₜᵣₐᵢₙ=Pr (y|x+δ_{D}, z; θ) (i.e., prediction loss function that is trained to ensure model robustness via noise added by δ_{D}).

Adversarial component 111 computes a second distance (step 312). In an embodiment, adversarial component 111, through analysis component 124, computes a distance (i.e., second distance) between \tilde{z} and z*ₜᵣₐᵢₙ (i.e., distance to consider the relevant historical training samples with respect to the task optimization cost).

In an alternative embodiment, “computes a second distance” (i.e., distance to consider the relevant historical training samples with respect to the task optimization cost), the following can be used as an additional and/or alternative step: (a) computing the difference between the output defined as: |\tilde{z}−z*ₜᵣₐᵢₙ (i.e., al for scar-based values); or (b) computing the Wasserstein Distance between \tilde{z} and z*ₜᵣₐᵢₙ (i.e., for distribution-based values).

Adversarial component 111 computes task defined cost function (step 314). In an embodiment, adversarial component 111, through analysis component 124, computes task-defined cost function g(\tilde{z}ₖ, yₜₑₛₜ) (i.e., used to minimize the task-defined cost function).

Adversarial component 111 calculates loss function (step 316). In an embodiment, adversarial component 111, through analysis component 124, calculates the total loss from values computed from steps 308, 310, 312 and 314.

In an alternative embodiment, calculating loss function can comprise of (a) deriving/calculating the total loss can be defined as a weighted sum of step (310) and step (314) whose weights are dependent on step (308) and step (312), (b) utilizing weights corresponding to the prediction loss, defined by 1/\hat{z}−z*ₜᵣₐᵢₙ|α or any function that increases in distance of the \tilde{z} and Z*ₜᵣₐᵢₙ or (c) another embodiment of this is utilizing weights corresponding to the task-optimization cost, defined by 1/\hat{z}−z*ₜᵣₐᵢₙ|β or any function that decreases in distance of the z*ₜₑₛₜ and z*ₜᵣₐᵢₙ.

Adversarial component 111 calculates gradient (step 318). In an embodiment, adversarial component 111, through analysis component 124, computes the gradient of the loss function (calculated from step 316).

Adversarial component 111 performs backpropagation (step 320). In an embodiment, adversarial component 111, through analysis component 124, performs backpropagation. Backpropagation can be defined as updating predictive model parameters and/or other values related to the task-defined cost function.

Adversarial component 111 determines if convergence has occurred (decision block 322). Recall that convergence was previously defined as either, (i) a process where the difference between the previous metric of interest and the same metric of interest in the current iteration has not changed by some threshold value defined by the user (or can evaluate this over a window of values in other instances), (ii) the number of epochs (iterations) has been reached (i.e., the epoch threshold can be defined and adjusted by the user) or (iii) the convergence score reaches some user-defined value. The counter is one method as a way to achieve convergence (or meet termination criteria). For example, if the user wanted to exit the calculation after 10 iterations then the termination criteria, are 10 for iterations. In an embodiment, adversarial component 111, determines if convergence has occurred by comparing a value in a counter against a termination threshold. For example, adversarial component 111 adds a count of one to the previously stored value in a counter (where the termination threshold value is 10, set by the user). If adversarial component 111, through analysis component 124, determines that the value of the counter is 11 then it can continue to the next step (i.e., step 324). However, if adversarial component 111 determines that the value of the counter is less than the threshold of 10, then adversarial component 111 returns to step 304 and repeats the process again until an exit criterion is reached (i.e., termination threshold).

In an alternative embodiment, adversarial component 111 utilizes another type of termination criteria based on other user defined parameters, such as epoch.

Adversarial component 111 outputs values (step 324). In an embodiment, adversarial component 111, outputs the calculated values. The values includes the following, but it is not limited to, (i) optimal learned model parameter and (ii) optimal task-defined objective function (e.g., Z*, g*and θ*). Based on the output values, a user (as a defender) can make a determination whether the trained model is robust enough to withstand adversarial attack (see “Defender” under threat model component 123 section).

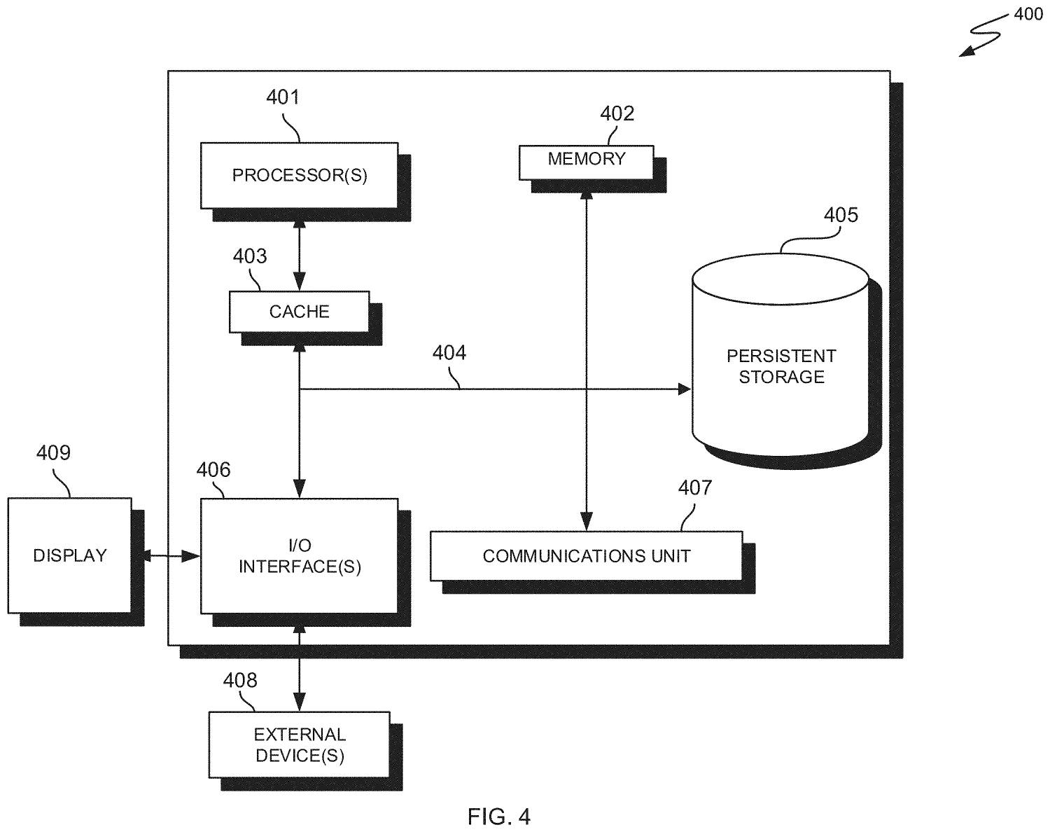

FIG. 4, designated as 400, depicts a block diagram of components of adversarial component 111 application, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 4 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data×10) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Adversarial component 111 can be stored in persistent storage 405 for access and/or execution by one or more of the respective processor(s) 401 via cache 403.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., adversarial component 111) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., adversarial component 111) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for providing prediction and optimization of an adversarial machine-learning model, the computer-method comprising:
receiving a set of input data associated with a training model, wherein the input data comprises of a training dataset, a testing dataset, task-defined cost function, possible action ranges, historical dataset and pre-train model weights;
determining a test optimal action value from the testing dataset based on threat assumption and the possible action ranges;
determining a training optimal action value from the training dataset based on output features of the training dataset and the possible action ranges;
computing a first distance between the test optimal action value and the training optimal action value;
computing a prediction loss function based the historical dataset;
computing a second distance between the possible action ranges and the training optimal action value;
computing the task-defined cost function based on the possible action ranges and the output prediction from the testing dataset;
calculating a total loss based on the first distance, the prediction loss function, the second distance and the task-defined cost function;
calculating a gradient of the total loss function;
performing a backpropagation on one or more parameters associated with the training model;
determining if convergence has occurred; and
responsive to the convergence has occurred, outputting the optimal actions, optimal learned model parameter and optimal task-defined objective function.

2. The computer-implemented method of claim 1, wherein:
the training dataset comprises one or more input features, one or more output features and one or more action values.

3. The computer-implemented method of claim 1, wherein determining a test optimal action value further comprises:
performing a feedforward inference for each of the possible action ranges, given the input testing set to derive a collection of predictions.

4. The computer-implemented method of claim 1, determining a test optimal action value further comprises:
solving for the optimal actions based on the task-defined optimization function, the various historical actions and the historical input values.

5. The computer-implemented method of claim 1, wherein computing the first distance by using an absolute value of the difference between the test optimal action value and the training optimal action value.

6. The computer-implemented method of claim 1, wherein computing the first distance is based on a Wasserstein distance between the test optimal action value and the training optimal action value.

7. The computer-implemented method of claim 1, wherein computing the second distance using an absolute value of the difference between the test optimal action value and the training optimal action value.

8. The computer-implemented method of claim 1, wherein computing the second distance is based on a Wasserstein distance between the test optimal action value and the training optimal action value.

9. The computer-implemented method of claim 1, wherein calculating the total loss utilizing weights corresponding to the prediction loss function as defined by 1/\hat{z}−z*ₜᵣₐᵢₙ|^{α}.

10. The computer-implemented method of claim 1, wherein calculating the total loss utilizing weights corresponding to the task-defined cost function, defined by 1/\hat{z}−z*ₜᵣₐᵢₙ|^{β}.

11. The computer-implemented method of claim 1, wherein determining if convergence has occurred further comprises of using an incrementing counter to count a number of iteration and comparing a value from the incrementing counter against a termination threshold.

12. A computer program product for providing prediction and optimization of an adversarial machine-learning model, the computer program product comprising:
one or more computer readable storage media and program instructions stored on the one or more computer readable storage media, the program instructions comprising:
program instructions to receive a set of input data associated with a training model, wherein the input data comprises of a training dataset, a testing dataset, task-defined cost function, possible action ranges, historical dataset and pre-train model weights;
program instructions to determine a test optimal action value from the testing dataset based on threat assumption and the possible action ranges;
program instructions to determine a training optimal action value from the training dataset based on output features of the training dataset and the possible action ranges;
program instructions to compute a first distance between the test optimal action value and the training optimal action value;
program instructions to compute a prediction loss function based the historical dataset;
program instructions to compute a second distance between the possible action ranges and the training optimal action value;
program instructions to compute the task-defined cost function based on the possible action ranges and the output prediction from the testing dataset;
program instructions to calculate a total loss based on the first distance, the prediction loss function, the second distance and the task-defined cost function;
program instructions to calculate a gradient of the total loss function;
program instructions to perform a backpropagation on one or more parameters associated with the training model;
program instructions to determine if convergence has occurred; and
responsive to the convergence has occurred, program instructions to output the optimal actions, optimal learned model parameter and optimal task-defined objective function.

13. The computer program product of claim 12, wherein:
the training dataset comprises one or more input features, one or more output features and one or more action values.

14. The computer program product of claim 12, wherein program instructions to determine a test optimal action value further comprises:
program instructions to perform a feedforward inference for each of the possible action ranges, given the input testing set to derive a collection of predictions.

15. The computer program product of claim 12, wherein program instructions to compute the first distance is based on a Wasserstein distance between the test optimal action value and the training optimal action value.

16. The computer program product of claim 12, wherein program instructions to compute the second distance is based on a Wasserstein distance between the test optimal action value and the training optimal action value.

17. A computer system for providing prediction and optimization of an adversarial machine-learning model, the computer system comprising:
one or more computer processors;
one or more computer readable storage media; and
program instructions stored on the one or more computer readable storage media for execution by at least one of the one or more computer processors, the program instructions comprising:
program instructions to receive a set of input data associated with a training model, wherein the input data comprises of a training dataset, a testing dataset, task-defined cost function, possible action ranges, historical dataset and pre-train model weights;
program instructions to determine a test optimal action value from the testing dataset based on threat assumption and the possible action ranges;
program instructions to determine a training optimal action value from the training dataset based on output features of the training dataset and the possible action ranges;
program instructions to compute a first distance between the test optimal action value and the training optimal action value;
program instructions to compute a prediction loss function based the historical dataset;
program instructions to compute a second distance between the possible action ranges and the training optimal action value;
program instructions to compute the task-defined cost function based on the possible action ranges and the output prediction from the testing dataset;
program instructions to calculate a total loss based on the first distance, the prediction loss function, the second distance and the task-defined cost function;
program instructions to calculate a gradient of the total loss function;
program instructions to perform a backpropagation on one or more parameters associated with the training model;
program instructions to determine if convergence has occurred; and
responsive to the convergence has occurred, program instructions to output the optimal actions, optimal learned model parameter and optimal task-defined objective function.

18. The computer system of claim 17, wherein program instructions to determine a test optimal action value further comprises:
program instructions to perform a feedforward inference for each of the possible action ranges, given the input testing set to derive a collection of predictions.

19. The computer system of claim 17, wherein program instructions to compute the first distance is based on a Wasserstein distance between the test optimal action value and the training optimal action value.

20. The computer system of claim 17, wherein program instructions to compute the second distance is based on a Wasserstein distance between the test optimal action value and the training optimal action value.
